(19) United States
(12) Patent Application Publication
(10) Pub. No.: US 2013/0263240 A1
(43) Pub. Date: Oct. 3, 2013

(54) METHOD FOR AUTHENTICATION AND VERIFICATION OF USER IDENTITY

(71) Applicant: Robert Moskovitch, Ashkelon (IL)

(72) Inventor: Robert Moskovitch, Ashkelon (IL)

(73) Assignee: DEUTSCHE TLEKOM AG, Bonn (DE)

(21) Appl. No.: 13/992,174

(22) PCT Filed: Dec. 4, 2011
(86) PCT No.: PCT/IL11/00920

§ 371 Date: Jun. 6, 2013

(30) Foreign Application Priority Data
Dec. 6, 2010 (IL) 209793

(51) Int. Cl. H04L 29/06

(52) U.S. Cl. CPC H04L 63/08
USPC 726/7

(57) ABSTRACT

The invention is a method for authentication and verification of the identity of a user. The method comprises adding at least one hidden keystroke to the user's textual credentials. A hidden keystroke is an action by a user that does not generate a textual character in a textbox in which a credential is typed but does generate time stamps and a key code. The user may be required to add the hidden keystroke/s at specific location/s in his/her textual credential field. The method of the invention can be used to authenticate and verify users wanting to access addresses, websites, devices, documents, and web pages on a communication network, or a specific application installed on the user's device or to access devices requiring confirmation of the user in order to be activated. The invention is also a document or address on a device or on a communication network or a device that can be accessed or activated only by providing one or more hidden keystrokes in a credential field comprised of a string of keystrokes

### FIELD OF THE INVENTION

The invention relates to the field of identity theft, in which the credentials of a user (username and password) are stolen and are exploited. Specifically the invention relates to methods for user authentication and verification and reducing the damages caused by identity theft.

### BACKGROUND OF THE INVENTION

Publications and other reference materials referred to herein, including reference cited therein, are incorporated herein by reference in their entirety and are numerically referenced in the following text and are respectively grouped in the appended bibliography which immediately precedes the claims.

The increasing use of the internet presents many opportunities for exploitation through identity theft. Identity theft is a fraud, in which someone pretends to be someone else in order to steal money or get other benefits: from the more traditional financial crimes that ranges from loan, mortgage, credit card, commodities and services frauds, to money laundering, trafficking human beings, stock market manipulation and even breaches of national security or terrorism. According to the non-profit Identity Theft Resource Center (ITRC) [http://www.idtheftcenter.org] identity theft from a consumer perspective is sub-divided into four categories:
Financial identity theft (using another's identity to obtain goods and services), for example a bank fraud and online payment fraud, i.e. paying with credit card or with an online payment service
Criminal identity theft (posing as another when apprehended for a crime)
Identity cloning (using another's information to assume his or her identity in daily life)
Business/commercial identity theft (using another's business name to obtain credit)

Identity theft is frequently used by intruders to access web accounts through the internet. Currently users typically identify themselves by a username (‘who I am’) and a password (‘what I know’). The common use of the same username, often an email address, and password for many online services increases the vulnerability whenever such information is stolen. Thus, when a website is hacked and its users' credentials are revealed they can often be used by the hacker to access other websites and services, which require authentication.

As a result of the incomplete security provided by the current methods, an additional security means is required for confirming the identity of a user. In order to overcome the problem of users reusing their username and password, it would be desirable to be able to force the user to use different and even unique password, or username for each service.

Since the terrorist attack on Sep. 11, 2001 there has been a growing interest in the use of biometrics for identity verification in general and as a source of potentially useful technologies for solving the problem of securing access in systems involving the use of computing devices, e.g., desktop, or laptop, and more portable devices, e.g. tablets and mobile phones and to information systems locally on a specific device, or over a network such as in internet websites.

Two types of biometrics are traditionally distinguished: physiological and behavioral. Physiological biometrics refers to physical measurements of the human body, such as fingerprint, face, hand (palm) geometry and iris. Physiological biometrics often relies on a snapshot (single moment) in which measurements of the users are scanned, however, this often relies on the assumption that physiological properties do not change very rapidly; therefore, they can easily be exploited for identity theft.

Behavioral biometrics [2] relates to the specific behavior of a human (user) along time in performing some task, such as signature writing, voice, and others.

The use of technology based on physiological biometrics in the internet is very limited because of the requirement of dedicated hardware devices which are costly and often not available. Recently laptops are being produced with a fingerprint verification device; however, this is still not very popular and can not be used for user verification in web applications. Moreover, the biometric scanners that are commonly used in applications are easy to deceive and in any case such scanners are not available in all computers.

The major difference among the physiological and the behavioral biometrics is the temporal aspect, which makes the latter harder to detect on the one hand but harder to imitate on the other hand. As a consequence of the former, behavioral biometrics has been largely ignored for user verification in the past.

One type of behavioral biometrics that has been researched extensively for more than two decades is keystroke dynamics. Using keystroke dynamics the user is verified based on his typing patterns. This approach relies only on a keyboard, which exists in every computer, and recently on mobile devices such as phones and tablets. Within the past three decades several studies were made in the use of keystroke dynamics for verification of users upon login and for free texts [1].

Keystroke dynamics can be captured via several different features extracted from the typing rhythm of the user including: latency between consecutive keystrokes, flight time, dwell time, based on the key down/press/up events, overall typing speed, frequency of errors, e.g. use of backspace and use of control keys, e.g. left/right shift. Keystroke dynamics methods do not necessarily employ all of these features; most of the applications measure often only latencies and dwell time. Some of the more commonly used keystroke metrics are shown schematically in FIG. 1. Features of keystroke sequences, often used for long texts verification, are typically extracted based on di-graph, tri-graph or (more generally) n-graph segments of the entire text. In these, the latencies, intervals and flight time are measured for each sequence of keystrokes.

An important and challenging obstacle to the use of keystroke dynamics for user verification is that users, especially for web applications, tend to interact from different locations and machines, e.g., their own desktop, laptop or an internet café, etc). These different machines might include varying types of input devices, e.g. keyboards. Moreover, recently with the increasing adoption of smartphones and tablets having virtual keyboards, the variety of devices and challenges are growing.

For the evaluation of biometric systems there are common measures, which we will be referred to herein below: False Acceptance Rate (FAR), which is the rate an imposter could be verified or identified by the biometric method, and False Rejection Rate (FRR), which is the rate a legitimate user is rejected by the biometric system. Cho et al. [3] measure the delay between key presses and the dwell time that are then processed in a multilayer perceptron neural network in order to discriminate between the user and an imposter. Adjusting the threshold they achieved a FAR of 0.0% and FRR of approximately 1%. The same characteristics were already used by Lin et al [4] who presented similar results (FAR 0.0%, FRR 1.1%) based on the input of passwords with the length of six to eight characters.

Lau et al. [5] state that formerly used metrics for verification do not perform very well. Therefore, they propose four new metrics: key press duration, relative key event order, relative keystroke speed and classes of shift key usage. They evaluated each metric on its own using a statistical analysis model. Revett et al. [6] analyzes keystrokes of the passphrase with a constant length of 14 characters for every user. They calculated a similarity measure to create a decision table and used this table to determine rules based on rough sets. With this method a 97% accuracy for a newly entered sample was achieved.

Bartmann et al. [7] patented a verification approach based on typing behavior. In this patent the features that can be used to verify users are described. Besides some of the ones mentioned herein above, they also propose using the overlapping of key presses, i.e. one key is held still while the next one is pressed, which is actually a negative interval (see FIG. 1). Additionally, the usage behavior of the shift keys is used. Another important aspect which is considered by Bartmann et al. is the fluctuation of the typing behavior and how to cope with these changes. Bartmann et al established a company, called Psylock [http://psylock.com/index.php/langen], which verifies the user based on an identical typed string of around 49 characters, which is used for all the users. Psylock is used at the University of Regensburg to enable users to reset their (lost) passwords [8] without the intervention of an administrator. Obviously, such a long password is not usable for daily use in websites and other services, which typically require a unique 8 characters password.

Bergadano et al. [9] proposed using relative duration times of n-graphs instead of absolute ones. In their method the graphs were sorted by their duration and then the distance between the single graphs is calculated and compared to other users typing samples' generated n-graphs.

Recently researchers have performed studies, in which users are verified according to their typing patterns using the phone keyboard [10], [11], [12], [13]. However, phones have become “smarter” in recent years and it is now more common to see phones with full keyboards, whether hard or virtual. Similarly there is an increasing trend of usage of tablets, e.g. iPad, in which often there is a virtual keyboard and an option to plug in a hardware keyboard. The present invention is relevant to these devices and refers to such devices, as well as to personal computers.

Despite all of this work and that of many other researchers, no practical method based on keystroke dynamics has yet gained wide spread acceptance for use in user identity verification.

It is a purpose of the present invention to provide an authentication and verification method overcomes the disadvantages of the prior art by forcing the user to use a different password and/or username for each online service to which this invention is applied.

Further purposes and advantages of this invention will appear as the description proceeds.

### SUMMARY OF THE INVENTION

In a first aspect the invention is a method for authentication and verification of the identity of a user. The method comprises adding at least one hidden keystroke to the user's textual credentials. A hidden keystroke is an action by a user that does not generate a textual character in a textbox in which a credential is typed but does generate time stamps and a key code.

In embodiments of the method of the invention the least one hidden keystroke is added to the user's textual credentials at a specific location.

Hidden keystrokes can be generated in at least one of the following ways:
a) pressing or clicking on certain standard keys on conventional physical or virtual keyboards;
b) typing a hidden pattern generated by pressing a combination of keys that includes the use of keys that eventually do not leave any text. but whose hidden sequence can be verified based on the timestamps;
c) pressing on a physical button adapted to generate a hidden keystroke; and
d) clicking on a virtual button, icon, or key implemented on the login interface that will generate a hidden keystroke behavior by clicking on it.

In embodiments of the method of the invention at least one artificial character is placed in a typed area to indicate to a user that he has entered a hidden key.

In embodiments of the method of the invention the password is comprised entirely of hidden keystrokes.

An embodiment of the method of the invention comprises two phases:
a) a registration phase, wherein:
i) a user registers to a service by typing his/her textual credentials including at least one hidden keystroke at a specific location in at least one of the text boxes of the credentials onto a registration page on the login component of his/her machine;
ii) the login component sends the textual credentials, the hidden keystroke/s and their locations, and the timestamps of the textual credentials and hidden keystroke/s to an authentication component; and
iii) the authentication component stores the textual credentials, generates an identifier, and sends the identifier, the hidden keystroke/s and their locations, and the timestamps to a verification component where they are stored for later reference;
b) an authentication phase, which is repeated each time the user logs into the service, the authentication phase comprising the steps:
i) the user types his/her textual credentials including hidden keystroke/s on a login page on the login component of his/her device, which transfers the textual credentials, the hidden keystroke/s and their locations, and the timestamps of the textual credentials and hidden keystroke/s to the authentication component;
ii) the authentication component authenticates the textual credentials by comparing them to credentials that were stored in the authentication component during the registration phase;
iii) the authentication component sends the hidden keystroke/s and their locations, the timestamps of the credentials, including the timestamps of the hidden key/s, which the user has typed on the login page, together with either the username, or with an identifier that the authentication component has generated to represent the username, to the verification component; and
iv) the verification component verifies that the identifier, the hidden keystroke/s and their locations, and the timestamps entered on the login page are the same as those entered by the user during the registration phase and returns an answer to the authentication component, which manages the entire process of authentication, whether the verification was successful or not.

The authentication component and the verification component can be implemented on one or more physical devices located on one or more networks.

In embodiments of the method of the invention timestamps need not used in the authentication phase because artificial characters are entered for each hidden key entered in the credential text boxes.

Embodiments of the method of the invention additionally comprise using a keystroke dynamics method to verify the identity of the user.

In embodiments of the method of the invention the login interface comprises only one textbox for the username and the password is composed entirely by hidden keys entered in the textbox.

In a second aspect the invention is the use of the method of the first aspect to authenticate and verify users wanting to access addresses, websites, devices, documents, and web pages on a communication network, or the device itself, or a specific application installed on the user's device.

In a third aspect the invention is a document or address on a device or on a communication network that can be accessed only by providing one or more hidden keystrokes in a credential comprised of a string of keystrokes.

In a fourth aspect the invention is a device that can be accessed or activated only by providing one or more hidden keystrokes at specified locations in a credential comprised of a string of keystrokes.

All the above and other characteristics and advantages of the invention will be further understood through the following illustrative and non-limitative description of embodiments thereof, with reference to the appended drawings.

### BRIEF DESCRIPTION OF THE DRAWINGS

FIG. 1 shows several different keystroke metrics, i.e. features that can be extracted from the typing rhythm of a user;

FIG. 2 schematically shows an authentication and verification architecture according to a first embodiment of the invention; and

FIG. 3A to FIG. 3C, FIG. 4A to FIG. 4C, and FIG. 5A to 5C schematically show examples of ways in which virtual buttons or keys for generating hidden keystrokes can be arranged on a login interface.

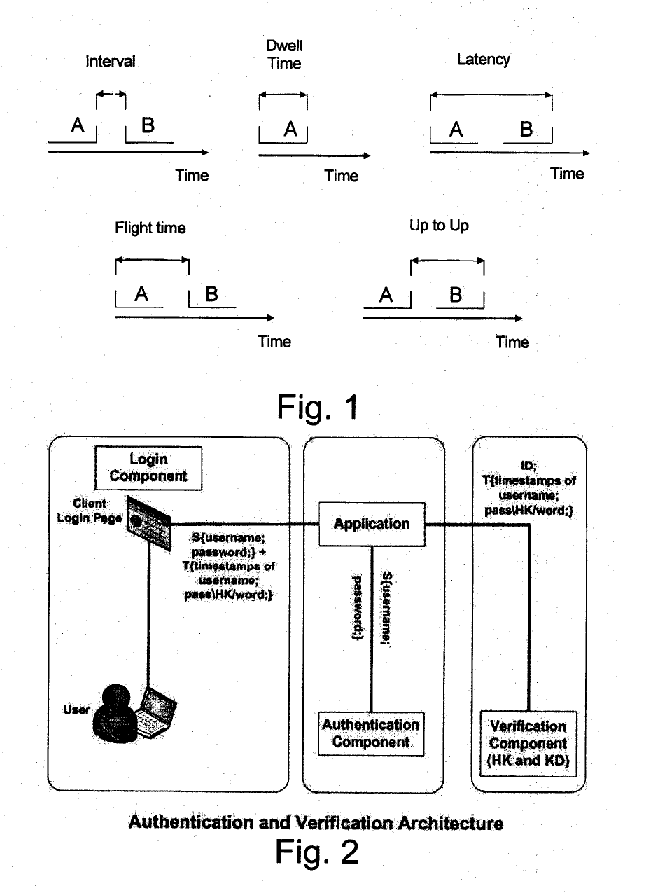

### DETAILED DESCRIPTION OF EMBODIMENTS OF THE INVENTION

The invention is an authentication and verification method for preventing the consequences of identity theft and minimizing its effectiveness. The invention adds an additional security layer to devices and websites by adding at least one hidden keystroke as an additional factor to the credentials that are presently used for authentication of a user's identity, thereby preventing authentication followed by stealing of the credentials.

The most familiar user credentials are the username and password. Some service providers, devices, etc. require that the user's credential comprise other textual information such as identity card numbers, passport numbers, birthdates, etc. The word “credentials” is a generic term used to represent any and all textual information that a user is required to supply to a password protected device or website in order to verify his or her identity. Herein the use of the words “username” and “password” are to be understood to refer to any part or all of the credentials of a user.

The method of the invention can either be used on its own or to extend and help to overcome some of the limitations of the keystroke dynamics method.

The present invention is applicable to the problem of identity theft in personal devices, such as personal computers and mobile devices, through which users frequently access their data locally or on websites. Identity theft can be used to access local valuable information stored on personal computers or mobile devices. The problem of identity theft will become more and more important with the increase in storage size and functionality. Another aspect of identity theft is unauthorized access to services provided through a network of computers, such as the internet, and intranet for organizations. The method of the invention can be used to authenticate and verify users wanting to access systems involving the use of computing devices, e.g., desktop, or laptop, tablets and mobile phones; to access addresses, websites, documents, and web pages on a communication network; and also to authenticate and verify users wanting to access local resources, i.e. devices and/or information that may be stored on the devices. With the growing connectivity of various devices such as cars, and various electrical devices, e. g. “smart” refrigerators, to the cellular and internet networks, the method of the invention can be used to include login to these devices such that they can only be accessed or activated after successful user authentication.

Before proceeding with the description of the invention, several definitions will be made first:

Definition 1: A keystroke in typing can be defined in many ways for both real keyboards and virtual keyboards either on the device, e.g. a mobile device, or at the webpage. For example, in current keyboards, such as those used on PC systems, there are three events: KeyDown, KeyPress and KeyUp. On mobile tablets or phone devices there are similar events. In the following a keystroke is defined by a triple k=<dt, ks, ut>, in which dt is the time stamp of the KeyDown event, ks is the code of the key that was pressed, and ut is the time stamp of the KeyUp event. It is to be understood however, that this definition is used only to illustrate the principle of the invention and that other definitions can be used in other frameworks. In some applications, for example in keystroke dynamics, the keystroke may be defined in terms of features extracted from the typing, such as Dwell-time, which is the duration of time in which a key is being pressed, or Interval-time, which is the duration of time between when a pressed key is released and the following key is pressed. A keystroke can also be defined in terms of a feature that refers to a keystroke that was pressed, ignoring the duration of time that it is pressed or flight time.

Definition 2: Using the definition of a keystroke as a triple k=<dt, ks, ut>, then a typed sequence of keystrokes is described as a list of keystrokes K={k₁, k₂, . . . ,kₙ}, in which each ki is a triple as described in definition 1, ordered by their down time (dt).

In some cases a list of keystrokes can be defined only in terms of part of the keystroke, e.g. as a list of keyDown events, or only keyUp events. The important thing is the order in which the keys are pressed. This way of defining a list of keystrokes is also relevant for the keystroke dynamics method, although obviously reducing the accuracy of the method.

Definition 3: In order to have separate representations of the typed characters (of the keystrokes) and the time stamps a sequence of typed keystrokes K can be represented by two lists S and T. S={s₁, s₂, . . . ,sₙ} contains the list of textual characters that were typed, while T={t₁, t₂, . . . tₙ}, contains a list of the time stamps of each regular or hidden (see definition 4) keystroke that was typed, in which each ti=<dt, ks, ut> is a pair of time stamps ordered according to the key down time stamp (dt).

Thus, whenever the user types a string K, such as a username or password there results two lists: S, containing the textual characters that were pressed, and T, containing the list of the time stamps of the keystrokes that were pressed in K.

Definition 4: A hidden keystroke is an action by the user that doesn't generate a textual character in a textbox in which a credential is typed in but does generate time stamps and the key code. In the context of this invention any action that produces the aforementioned result will be known as a “hidden keystroke”.

Hidden keystrokes can be generated in many ways some examples of which are:
pressing certain standard (i.e. classical hidden) keys on conventional physical or virtual keyboards, e.g. Delete, End, arrows: ↑, ↓, →, all of the F1-F12 keystrokes, Ctrl, Alt, and Esc;
a hidden pattern generated by pressing a combination of keys that eventually doesn't leave any text; but whose hidden sequence can be verified based on the timestamps. For example: a usernamed “bruce” could type in the password window on the login page the sequence p,a,s,s,b,r,u,c,e,←,←,←, ←, ←,Del,Del,Del,Del,Del,w,o,r,d; or, as another example, p,a,s,s,w,o,r,d,b,r,u,c,e,←,←, ←, ←, ←,End, Bkspc, Bkspc, Bkspc, Bkspc, Bkspc. In both case only the word “password” (or “********”) would be visible on the screen and the hidden pattern (in this example the user's name) would be hidden;
a physical button that has been modified by being given the ability to generate a hidden key. The physical button can be an existing feature of a device, e.g. the on/off button, the camera button on a mobile phone, the door handle of a smart fridge, and pressing the horn, or turning the lights in a car or it can be a special switch or button that has been added for the purpose of generating a hidden key;
a virtual button, icon, or key implemented on the login interface that will generate a hidden keystroke behavior by clicking on it.

Definition 5: Given a typed sequence of keystrokes K the size |S| of the list of typed keystrokes S is equal to or smaller than the size |T| of the list of time stamps, i.e. |S|≦|T|. This is true because, all of the keystrokes K, including hidden keystrokes, will appear in the list T; however, if some of the keystrokes K are hidden keystrokes they will not appear in the list S.

Definition 6. Identity theft is a malicious activity that is carried out by a person to illegally obtain the credentials, e.g. the password and username of a user. Identity theft can be carried out in many ways, for example, by hacking into an existing online system and getting all the credentials of the system, which are often the same in other online services, or by phishing websites, i.e. by manipulating users to provide their credentials. Identity theft can also be carried out in other ways, for example a worker of a website can steal or without authorization expose all or part of the database of the website to others.

Definition 7: An identifier can be the actual username. However, as a security feature that keeps the username from being stored in the system it can be code that represents the username and that is preferably dynamically generated each time the user types in his username during registration and verification.

The novelty in this invention is an additional factor added to the credentials of the user by asking him/her to type at least one hidden keystroke during the typing of the username, password, or both. Consequentially, the difference between a string typed without a hidden keystroke and with one is observed only in the list T and not in S. Although the method will give good results using only a single hidden keystroke, the accuracy and reliability of the verification, whether combined with keystroke dynamics or not, is increased as the number of hidden keystrokes is increased. It is also noted that in an embodiment of the invention the password, username, or both may be comprised entirely of hidden keystrokes. Requiring the user to add the hidden keystrokes to the password, or username, forces the users of the service to create a unique password that cannot be found in another repository, especially when the virtual button, icon, or key, are implemented with symbols that are unique to the service.

More formally, given a typed string K and the same typed string including a hidden keystroke in, for example, location 3 (after the third keystroke) K³ₕ, in which S and T and S³ₕ and T³ₕ are the list of keystrokes and the time stamps respectively for K are K³ₕ; then, as was explained in definition 5, the number of typed keystrokes |S| and |S³h| are equal however the number of time stamps |T| is smaller than |T³ₕ|.

Even if a database of strings, e.g. username and passwords, were compromised and the username and password were stolen, according to the invention their corresponding time stamps T, which can be stored in another location and synchronized by an identifier through, for example, a HASH function would also have to be stolen. Storing T and S at separate locations, i.e. on different components in the same or different network, presents an additional safety factor, since information other than S that is known to the user, i.e. the identity of the hidden keystroke/s and its/their location in the string, exists only in T.

Definition 8: An artificial character is a visible sign placed in the typed area, e.g. textbox, to indicate to the user that he has indeed pressed on a hidden key. Artificial characters are useful, for example, when a user is required to use a virtual button, icon, or key implemented on the login interface to generate a hidden keystroke while entering his password or username. They are especially relevant in passwords fields, in which the content is often hidden and only a sign, such as ‘*’, is presented to the user upon typing a non-hidden keystroke. The character entered when clicking on the virtual button, icon, or key is not necessarily the actual code of the hidden key that the button represents. Depending on the application, after the typing is completed the artificial character can be filtered out so that it will not be part of the typed string of the username or password.

If, as a result of the use of an artificial character, the hidden key code, i.e. the artificial character, is a part of the textual string, then, using the example given above, definition 5 does not apply. In this case not only will |T| be smaller than |T³ₕ| but also |S| will be smaller than |S³ₕ|.

Using a distributed architecture scheme there are two constituent parts of the verification scheme of the invention that are stored on components in the system. The first constituent is the textual username and textual password that are stored as is done today in the currently used authentication methods. The second constituent, which is unique to the present invention, is the time stamps of the typing, including hidden keystrokes and their time stamps. According to the invention, these two constituents can be stored in the same place, but are preferably stored at different locations, i.e. on different physical devices either within the same network or on different networks. It is noted that the option of storing both constituents of the verification scheme of the invention at the same location, i.e. on one physical device including on the device of the user, will be effective but much less secure than storing them at different locations, i.e. on two different physical devices.

FIG. 2 schematically shows an authentication and verification architecture in which the hidden keys are used together with the username and password to authenticate and verify the identity of the user. The authentication and verification architecture of the invention is comprised of the following main components:
a) a login component that is physically located on the user's device, e.g.

computer or mobile phone, or on a device that the user is attempting to activate, e.g. a password protected automobile, bicycle or refrigerator; or a login webpage on the internet;
b) an application or device that the user is attempting to access;
c) a verification component adapted to use timestamps of the username and password, including hidden keystrokes, to verify the username and password and, in some embodiments, also to carry out a keystroke dynamics verification method; and
d) an authentication component adapted to perform authentication of the user's password and username in a first stage to the verification component and in a final stage to the application component.

As described herein, the architecture and the functions of its components can be implemented on one or more physical devices in a system. Thus, the entire architecture can be implemented within a single computing device, e.g a mobile phone, tablet, PC, or it can be distributed on several computing devices. With the distributed architecture the authentication is performed on the device that the application is operating from, or a client page of the application, and the verification of the hidden keys and the keystroke dynamics is made on another device. The data that goes from the application component can contain the entire set of timestamps, in which case the verification component strips out the hidden keys and their locations. Alternatively the stripping/extraction of the hidden keys and their locations can be carried out on the application component, which send only this data to the verification component.

Referring to FIG. 2, the method of the invention comprises the following phases:
a) Registration—In this phase the user registers to the service. The user types into the registration page on the login component his/her username and a password, including at least one hidden keystroke at a specific location in the username, the password, or in both. The choice of hidden keystroke/s and location/s can made by the user or supplied to the user by the system.

In a less secure embodiment of the invention the user may be required to insert one or more hidden keystrokes at any location in his/her username, password, or in both.

After the user has finished filling in the registration page, the textual password and username are sent to the authentication component and the time stamps of the password and the username, including the timestamps of the hidden keys are sent to the verification component, where they are stored to be used in the authentication phase of the invention. If it is desired that the verification component will not be exposed to the username and textual password, then the time stamps of the hidden keys and their locations are extracted at the authentication component and are sent to the verification component, in which they are stored for later verification.

In the initial registration step it might be advantageous for the service provider to request the user to enter the password and username with the hidden keystroke twice as is commonly done in order to verify that they are the same.
b) Authentication and Verification—This phase is repeated each time the user logs into the service and comprises the following steps:
i) The user types his/her username and password including the hidden keystrokes—in embodiments that require it at the same locations as in the registration phase—on a login page on his/her login component, which transfers them to the authentication component.
ii) The authentication component authenticates the textual username and password by matching the username and password typed on the login page against username and password that were stored in the authentication component during the registration phase.
iii) The authentication component sends the timestamps of the username and password, including the timestamps of the hidden key/s, that the user has typed in together with either the username or, preferably for security reasons, with an identifier that it has generated to represent the username, to the verification component. In the case that only the timestamps of the hidden keys and their locations were stored in the verification component during the registration phase, also in the authentication phase the hidden keys and their locations will be extracted from the timestamps by the authentication component and sent to the verification component.
iv) The verification component verifies that the hidden keystroke or keystrokes and their locations entered on the login page are the same as those entered by the user during the registration step and returns an answer to the authentication component, which manages the entire process of authentication, whether the verification was successful or not.

In embodiments of the invention the verification step can be carried out without the use of the timestamps if artificial characters are entered for each hidden key entered in the credential text boxes.

In embodiments of the invention the hidden keystroke verification can be used together with a keystroke dynamics method carried out on the verification component. In this case the verification component independently uses the time stamps as input to a keystroke dynamics method to verify the identity of the user and the results of both methods of verification are returned to the authentication component.

If keystrokes dynamics are used then in the registration step it is advantageous for the user to enter the password and username with the hidden keystroke several times, e.g. ten times, in order to allow the learning component of the chosen keystroke dynamics method to begin to “learn” the relevant typing characteristics of the user. This is not necessary however and, if it is not done, the keystroke dynamics method is able to learn implicitly from the first logins of the user after registering; however the more information that is initially supplied to the keystrokes dynamic method the faster it can become an effective tool for authenticating and verifying the user's identity.

As previously noted the authentication and HK authentication can be carried out on the same physical device in the system; however distributing the username and password, i.e. the textual information, and the hidden keystroke/s and its location on two (or more) physical devices as shown in. FIG. 2 has three main advantages:
1. Security—with the architecture shown in FIG. 2, in order to be able to log into the system a hacker has to hack to both physical devices, i.e. a first physical device comprising the authentication component, in which the username and password are stored; and a second physical device comprising the verification component in which the hidden keystroke and its location are stored. As an additional security measure the authentication component and verification component can be present on physical devices in separate networks. In this case, if a hacker hacks into one of the networks she will not be able to access the other component. Even if the entire architecture is implemented on a single device, it is still beneficial to store the data for each of the components in separate locations.
2. Two or three factor authentication: a) the username and password b) the hidden keystrokes and their locations and, c) when keystroke dynamics verification is used—the typing patterns.
3. Seamless integration—current authentication systems consist of a username and password, which are textual, i.e. the first constituent of the verification scheme of the invention, and therefore this embodiment of the invention can be used with very few changes to existing authentication methods.

Finally, in order to combine all of the aspects of the invention, e.g. the username; the password; the time stamps of the password, including the hidden keystrokes; and the score of the verification, in addition to other static factors, e.g. the IP, the browser, and time zone of the login, an administrator can define various weights for each factor in order to sum a risk score according to the requirements of the system.

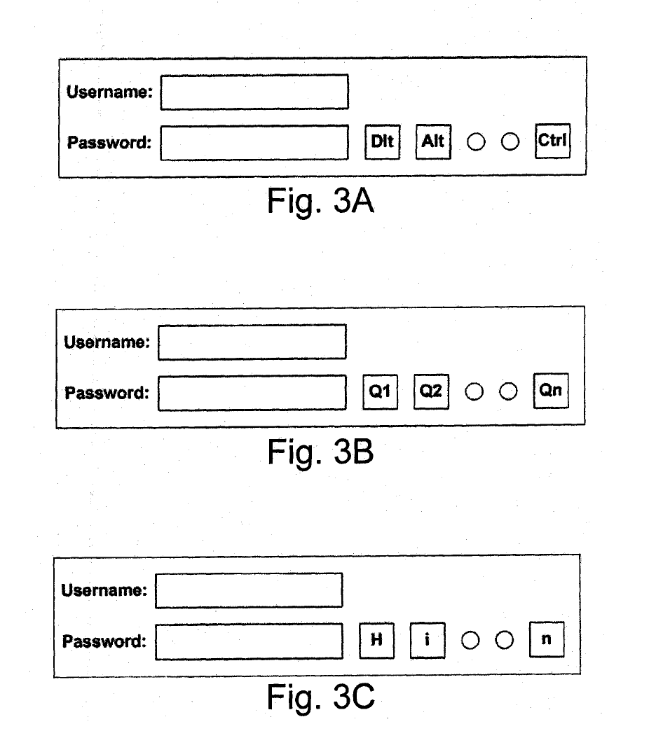

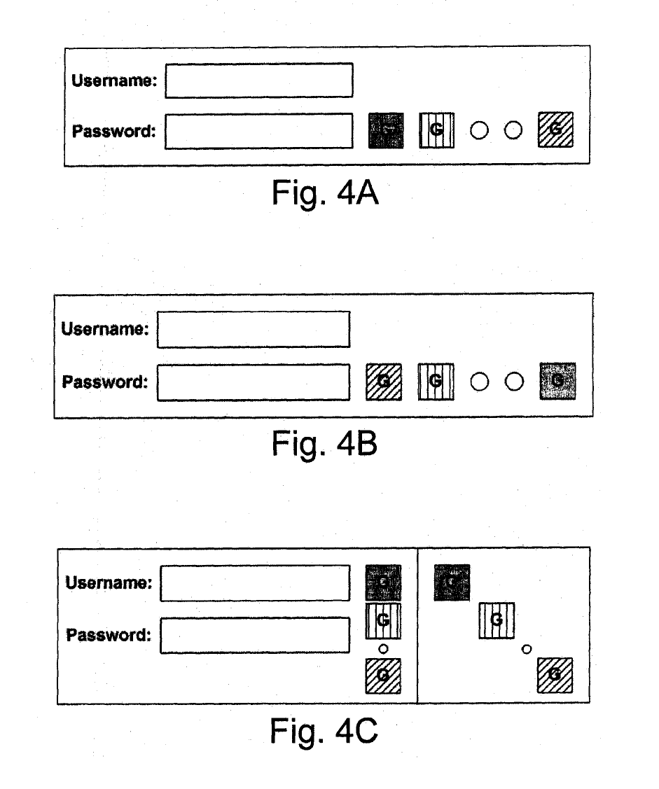

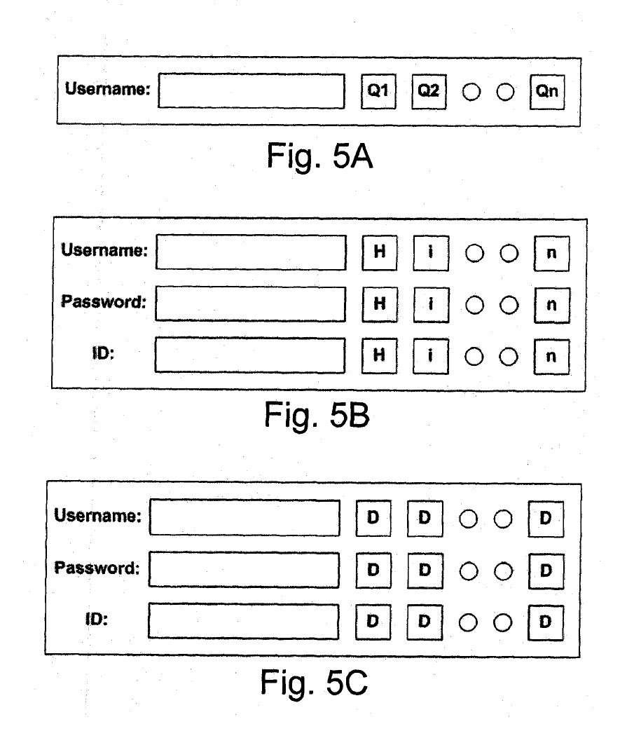

FIG. 3A to FIG. 3C and FIG. 4A to FIG. 4C schematically show examples of some of the many ways in which virtual buttons, icons, or keys, which will generate a hidden keystroke behavior by clicking on them, can be arranged on a login interface.

FIG. 3A shows a login interface with the “classical” hidden keys, e.g. Delete, Alt, and Control (Ctrl), presented as virtual buttons, icons, or keys. This choice of keys especially complements virtual keyboards on touch based interfaces (for example, mobiles and tablets) on which they do not exist.

FIG. 3B shows that the virtual buttons, icons, or keys can be represented by pictures or symbols, sometimes known as enumerated chars [Q1], [Q2], . . . [Qn].

FIG. 3C is similar to FIG. 3B but in this case shows letters, which, for example, could be the letters of the name of the website or any other word, e.g. “[H][i][d][d][e][n][K][e][y][s]”.

FIG. 4A shows an example of a login interface in which all the virtual buttons or keys have the same sign (character) but with different backgrounds or colors.

FIG. 4B and FIG. 4C shows that the virtual buttons or keys in FIG. 4A can be presented each time in a different order or orientation to provide more security by overcoming various potential replaying attacks.

FIG. 5A schematically shows that the invention allows the login interface to comprise only one textbox for the username. In this case the password is composed entirely by hidden keys, which can be entered using real hidden keystrokes on a physical keyboard or virtual buttons, icons, or keys, as shown, on a virtual keyboard.

FIG. 5B schematically shows that the invention allows the login interface to include textboxes comprising different parts of the user's credentials, in this example username, password and ID. The invention allows use of a set of hidden keys for each credential textbox. The user may choose or be instructed to press one or more hidden keys in one or more of the textboxes.

FIG. 5C schematically shows that the invention allows the use of multiple virtual hidden keys that appear the same, but might generate a different code that distinguishes at least one of them from the others.

Although embodiments of the invention have been described by way of illustration, it will be understood that the invention may be carried out with many variations, modifications, and adaptations, without exceeding the scope of the claims.

### Bibliography

[1] A Peacock, X Ke, M Wilkerson, Typing Patterns: A Key to User Identification, IEEE Security & Privacy, 1540-7993/04, 2004.

[2] R. V. Yampolskiy, V. Govindaraju, Behavioral Biometrics: a Survey and Classification, Int. J. Biometrics, Vol. 1, No. 1, 2008.

[3] S. Cho, C. Han, D. H. Han, and H. I. Kim. Web-Based Keystroke Dynamics Identity Verification Using Neural Network. Journal of Organizational Computing and Electronic Commerce, 10(4):295-307, 2000.

[4] Daw-Tung Lin. Computer-access authentication with neural network based keystroke identity verification. Neural Networks, 1997

[5] E. Lau, X. Liu, C. Xiao, and X. Yu. Enhanced User Authentication Through Keystroke Biometrics. Technical report, Massachusetts Institute of Technology, 2004.

[6] K. Revett, P. S. Magalhaes, and H. D. Santos. Developing a keystroke dynamics based agent using rough sets. In 2005 IEEE/WIC/ACM International Joint Conference on Web Intelligence and Intelligent Agent Technology. University of Technology of Compiègne, 2005.

[7] D. Bartmann and D. Bartmann. Method for verifying the identity of a user of a data processing unit with a keyboard designed to produce alphanumeric characters. European Patent Number EP 0 917 678 B1, 1997.

[8] D. Bartmann and M. Wimmer. Kein Problem mehr mit vergessenen Passwörtern. Datenschutz and Datensicherheit-DuD, 31(3):199-202, 2007

[9] F. Bergadano, D. Gunetti and C. Pcardi, 2002: User Authentication through Keystroke Dynamics. ACM Transactions on Information and System Security, Vol 5(4), pp. 367-397.

[10] S Hwang, S Cho, S Park, Keystroke dynamics-based authentication for mobile devices, computers and security, 2 8:85-93, 2009.

[11] N. L. Clarke, S. M. Furnell, Advanced user authentication for mobile devices, computers & security 26 (2007) p. 109-119

[12] N. L. Clarke, S. M. Furnell. Authentication of users on mobile telephones. A survey of attitudes and practices. August 2005.

[13] Clarke N, Furnell S, Lines B, Reynolds P. Using keystroke analysis as a mechanism for subscriber authentication on mobile handsets. In: Proceedings of IFIP SEC 2003, Athens, Greece; 26e28 May 2003. p. 97-108.

1. A method for authentication and verification of an identity of a user, said method comprising:
determining, on a device, a user's textual credentials for authenticating the user as a user of a service;
adding at least one hidden keystroke to said user's textual credentials;
wherein said hidden keystroke is generated by an action of said user that does not generate a textual character in a textbox in which a credential is typed but does generate at least one time stamp and a key code.

2. The method of claim 1, wherein the least one hidden keystroke is added to the user's textual credentials at a specific location.

3. The method of claim 1, wherein hidden keystrokes are generated in at least one of the following ways:
a) selecting at least one certain standard key on a keyboard;
b) typing a hidden pattern generated by pressing a combination of keys on a keyboard that includes the use of keys that eventually do not leave any text. but whose hidden sequence can be verified based on the timestamps;
c) selecting a physical button adapted to generate a hidden keystroke; and
d) selecting a virtual button, icon, or key implemented on a login interface that will generate a hidden keystroke behavior.

4. The method of claim 1, wherein at least one artificial character is placed in a typed area to indicate to a user that he has entered a hidden key.

5. The method of claim 1, wherein the user's textual credentials are comprised entirely of hidden keystrokes.

6. The method of claim 1 further comprising:
a) a registration phase, wherein:
i) the device receives the user's textual credentials including at least one hidden keystroke at a specific location in at least one text box on a registration page on a login component;
i) said login component sends said textual credentials, said at least one hidden keystroke and the specific location, and the time stamp of said textual credentials and at least one hidden keystroke to an authentication component; and
ii) said authentication component stores said textual credentials, generates an identifier, and sends said identifier, said at least one hidden keystroke and the specific location, and said time stamp to a verification component where they are stored for later reference;
b) an authentication phase, which is repeated each time said user logs into said service, wherein:
i) the device receives the user's textual credentials including at least one hidden keystroke on a login page on the login component and transfers said textual credentials, said at least one hidden keystroke and the specific location, and the time stamp of said textual credentials and said at least one hidden keystroke to said authentication component;
ii) said authentication component authenticates said textual credentials by comparing said textual credentials to credentials stored in said authentication component during said registration phase;
iii) said authentication component sends said at least one hidden keystroke and the specific location, said time stamp of the textual credentials, including the timestamps of the at least one hidden keystroke received on said login page, together with either a username, or with an identifier that said authentication component has generated to represent said username, to said verification component; and
iv) said verification component verifies that said identifier, said at least one hidden keystroke and the specific location, and said time stamp received the login page are the same as those received during said registration phase and returns an answer to said authentication component, wherein the answer indicates whether a verification was successful or not;
wherein, said authentication component and said verification component can be implemented on one or more physical devices located on one or more networks.

7. The method of claim 6, wherein the time stamp is not used in the authentication phase, and wherein artificial characters are received on the device for each at least one hidden keystroke entered in the credential text boxes.

8. The method of claim 6, comprising additionally using a keystroke dynamics method to verify the identity of the user.

9. The method of claim 1, wherein the device comprises a login interface comprising only one textbox for the username, and wherein the password is composed entirely by hidden keystrokes entered in said textbox.

10. The method of claim 1, wherein the service comprises at least one of: an address, a website, a device, a document, an application, and at least one web page on a communication network.

11. (canceled)

12. A device comprising:
at least one processor, wherein said processor is configure to:
determine a user's textual credentials for authenticating the user as a user of a service; and
add at least one hidden keystroke to said user's textual credentials, wherein said at least one hidden keystroke is generated by a user action that does not generate a textual character in a textbox in which a credential is typed but does generate at least one time stamp and a key code.
